(19) United States
(12) Patent Application Publication
(10) Pub. No.: US 2011/0127904 A1
(43) Pub. Date: Jun. 2, 2011

(54) LIGHTING MODULE

(76) Inventor: Wen-Kuei TSAI, Taipei (TW)

(21) Appl. No.: 12/938,037

(22) Filed: Nov. 2, 2010

Related U.S. Application Data
(60) Provisional application No. 61/264,842, filed on Nov. 30, 2009.

(51) Int. Cl. H01J 1/62

(52) U.S. Cl. 313/501

(57) ABSTRACT

An embodiment of the present invention provide a lighting module, which comprises a carrier, at least one light source disposed on and electrically connected with the carrier, a molding compound mixed with a fluorescent material to encapsulate the light source and a portion of the carrier, and a color temperature converter disposed over or doped into the molding compound.

### CROSS-REFERENCE TO RELATED APPLICATION

This application claims the priority benefits of U.S. provisional application Ser. No. 61/264,842, filed on Nov. 30, 2009 and entitled “Lighting Module With Modulated Color Temperature,” the entire content of which is incorporated herein by reference.

### BACKGROUND OF THE INVENTION

1. Field of the Invention

The present invention generally relates to lighting modules, and more particularly, to lighting modules with modulated color temperature.

2. Description of Related Art

FIG. 1 is a cross-sectional view of a conventional light-emitting diode (LED) module 100. The conventional LED module 100 includes a printed circuit board (PCB) 110, at least one LED chip 120 disposed on and electrically connected with the printed circuit board 110, and an molding compound 132 formed on the printed circuit board 110 to encapsulate the LED chip 120. In conventional design for emission of white light, typically the LED chip 120 is responsible for emitting blue light (i.e., a blue LED chip), and the molding compound 132 includes yellow fluorescent particles 134 such as Yttrium Aluminum Garnet fluorescent particles (YAG) for being excited by the blue light and thus emit yellow light, and finally the blue light and the yellow light are mixed to result in white light vision with a predetermined color temperature. One skilled in the art knows that altering the quantity or composition of the yellow fluorescent particles 134 can modulate the color temperature of the white light LED.

Currently, white light LEDs with color temperature of 6000K, 4200K, 3000K, and so on have been available in the market. For various applications and requirements, white light LEDs with other color temperatures, e.g., 5000K or 2800K, are requested. For developing light-emitting diodes with specific color temperatures, manufacturers have spent much time and cost to study the composition of the yellow fluorescent particles 134. In addition, the developed composition suffers from unstable problems and its stability needs time to be confirmed; otherwise the yield cannot be increased.

Therefore, it would be advantageous to propose a solution to overcome the above-mentioned deficiencies of the prior art.

### SUMMARY OF THE INVENTION

Accordingly, the present invention is directed to a lighting module with modulated color temperature.

The present invention provides a lighting module. The lighting module includes a carrier, at least one light source, a molding compound, and a color temperature converter. The light source comprises a light emitting diode chip disposed on and electrically connected to the carrier. The molding compound encapsulates the light source and a portion of the carrier, wherein the molding compound comprises a fluorescent material. The color temperature converter is disposed over the molding compound. Accordingly, the light-emitting diode chip emits a first light to excite the fluorescent material to emit a second light, the first light and second light is blended, and the color temperature converter modulates the color temperature and uniformity of the blended light.

In an embodiment, the carrier comprises a printed circuit board, a ceramic circuit substrate, or a leadframe, and the printed circuit board comprises a metal-core printed circuit board with an Al or Cu core layer.

In an embodiment, the light-emitting diode chip is a blue light emitting diode chip, and the fluorescent material comprises yellow fluorescent particles.

In an embodiment, the light emitting diode chip is an ultraviolet light emitting diode chip, and the fluorescent material comprises red fluorescent particles, green fluorescent particles, blue fluorescent particles, or a combination thereof.

In an embodiment, the color temperature converter entirely covers the molding compound.

In an embodiment, the color temperature converter comprises an optical lens doped with a plurality of dopants, and the optical lens encapsulates the molding compound and a portion of the carrier.

In an embodiment, the optical lens is made of silicon or epoxy resin.

In an embodiment, the color temperature converter is disposed above the molding compound, and a space exists between the color temperature converter and the molding compound.

In an embodiment, the color temperature converter comprises an optical filter.

In an embodiment, the color temperature converter comprises a substrate doped with a plurality of dopants, the substrate comprises a plastic plate or a glass lens, the dopants comprise colourful particles or colourful plastic particles, and the colourful plastic particles comprise polycarbonate particles or silica gel particles.

The present invention further provides a lighting module that includes a carrier, at least one light source, a molding compound, and a plurality of color temperature dopants. The light source comprises a light emitting diode chip disposed on the carrier and electrically connected to the carrier. The molding compound encapsulates the light source and a portion of the carrier, wherein the molding compound comprises a fluorescent material. The color temperature dopants are doped within the molding compound. Accordingly, the light-emitting diode chip emits a first light to excite the fluorescent material to emit a second light, the first light and second light is blended, and the dopants modulates the color temperature and uniformity of the blended light.

In an embodiment, the carrier comprises a printed circuit board, a ceramic circuit substrate, or a leadframe, and the printed circuit board comprises a metal-core printed circuit board with an Al or Cu core layer.

In an embodiment, the light-emitting diode chip is a blue light emitting diode chip, and the fluorescent material comprises yellow fluorescent particles.

In an embodiment, the light emitting diode chip is an ultraviolet light emitting diode chip, and the fluorescent material comprises red fluorescent particles, green fluorescent particles, blue fluorescent particles, or a combination thereof.

In an embodiment, the dopants comprise colourful particles or colourful plastic particles, and the colourful plastic particles comprise polycarbonate particles or silica gel particles

Accordingly, the embodiments of the present invention provide the color temperature converters that can modulate the color temperature of light emitted from the light source, i.e., the LED chip. Compared with the prior art, the present invention provides more effective and easy way to modulate the color temperature of the light. The color temperature converters provided by the embodiments not only modulate the color temperature but also make the exported light more uniform.

It is to be understood that both the foregoing general descriptions and the detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a conventional light-emitting diode (LED) module.

FIG. 2 is a cross-sectional diagram of lighting module according to an embodiment of the present invention.

FIG. 3 is a cross-sectional diagram of lighting module according to another embodiment of the present invention.

FIG. 4 is a cross-sectional diagram of lighting module according to another embodiment of the present invention.

FIG. 5 is a cross-sectional diagram of lighting module according to another embodiment of the present invention.

FIG. 6 is a cross-sectional diagram of lighting module according to another embodiment of the present invention.

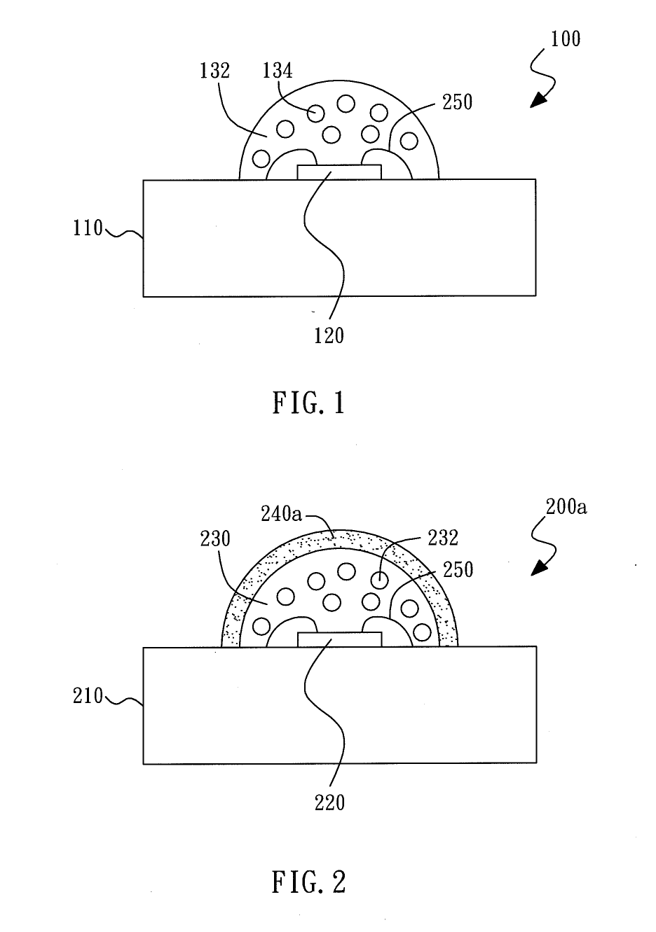

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a cross-sectional diagram of lighting module according to an embodiment of the present invention. Referring to FIG. 2, a lighting module 200a comprises a carrier 210, at least one light source 220, a molding compound 230, and a color temperature converter 240a. Functions of the elements and relationships between elements of the lighting module 200a will be described below with reference to the accompanying drawings.

In detail, the light source 220 is disposed on the carrier 210 and electrically connected to the carrier 210 through at least one wire 250. Here, two wires 250 are shown for illustration purposes. In addition, in the present embodiment the carrier 210 may be a printed circuit board, a leadframe, a ceramic circuit substrate, or other suitable substrates. In an embodiment, the printed circuit board is a metal-core printed circuit board with an Al or Cu core layer. In this embodiment, the light source 220 is a light-emitting diode (LED) chip, such as a blue LED chip, a red LED chip, a green LED chip, a purple LED chip, or an ultraviolet light LED chip. In this text, “a blue LED chip” refers to a light-emitting diode capable of emitting blue light, “a red LED chip” refer to a light-emitting diode capable of emitting red light, and so on.

Further, the molding compound 230 encapsulates the light source 220 and a portion of the carrier 210, wherein the molding compound 230 comprises a fluorescent material 232. The molding compound 230 is employed for protecting the light source 220 and the wire 250 from being affected or interfered by temperature, humidity, and signals in the environment. In this embodiment, the molding compound 230 is made of silicon or epoxy resin, but not limited. The fluorescent material 232 may comprise a plurality of fluorescent particles, such as yellow fluorescent particles.

Further, the color temperature converter 240a is disposed over the molding compound 230. Specifically, in the present embodiment, the color temperature converter 240a entirely covers the molding compound 230, and methods for forming the color temperature converter 240a may comprise spin coating, dip coating, ink jet, and the likes.

It should be noticed that, typically white light emission is a blended light of various lights with different colors. That is, the white light seen by human's eyes is one formed by two or more lights with different wavelengths. For example, the white light vision may be formed by blending blue light and yellow light, or, by blending red light, green light, and blue light.

Preferably, the lighting module 200a is designed for white-light emission. To this end, the light source 220 may be a blue light LED chip and the fluorescent material 232 embedded in the molding compound 230 comprises yellow fluorescent particles. The wavelengths emitted from the blue light LED chip range from 440 nm to 490 nm, and the yellow fluorescent particles will be excited after irradiation by the blue light and thus emit yellow light. Finally, the yellow light is blended with the blue light and results in white light vision.

In another embodiment, the light source 220 is an ultraviolet light LED chip and the fluorescent material 232 comprises red fluorescent particles, green fluorescent particles, blue fluorescent particles, or combination thereof. The wavelengths of the ultraviolet light range from about 380 nm to about 450 nm. The red, green, or blue fluorescent particles will be excited by the ultraviolet light and thus respectively emits red, green, and blue light. Finally, the ultraviolet light is blended with the red, green, or blue light or combination thereof and results in white light vision.

In short, the light source 220 emits light to the outside sequentially through the molding compound 230 and the color temperature converter 240a. Two events are occurred in sequence in the light path. Firstly, the light source 220 emits a light to excite the fluorescent material 232 and thus the fluorescent material 232 emits another light, and the later emitted light is blended with the former emitted light. Secondly, the blended light passes through the color temperature converter 240a that modulates the blended light and results in the exported light having a desired color temperature and a better color uniformity.

The prior art modulates the color temperature by altering the quantity or composition of fluorescent particles. Compared with the prior art, the embodiment of the present invention provides the color temperature converter 240a that can more effectively and easily modulate the color temperature of the light.

According to the present invention, the color temperature converter 240a may be carried out in several ways. The following embodiments describe some other modes of the color temperature converter (240b-240d and 340). For simplicity, the same or the like reference numerals denote the same or like elements as described before, and the descriptions of which are omitted.

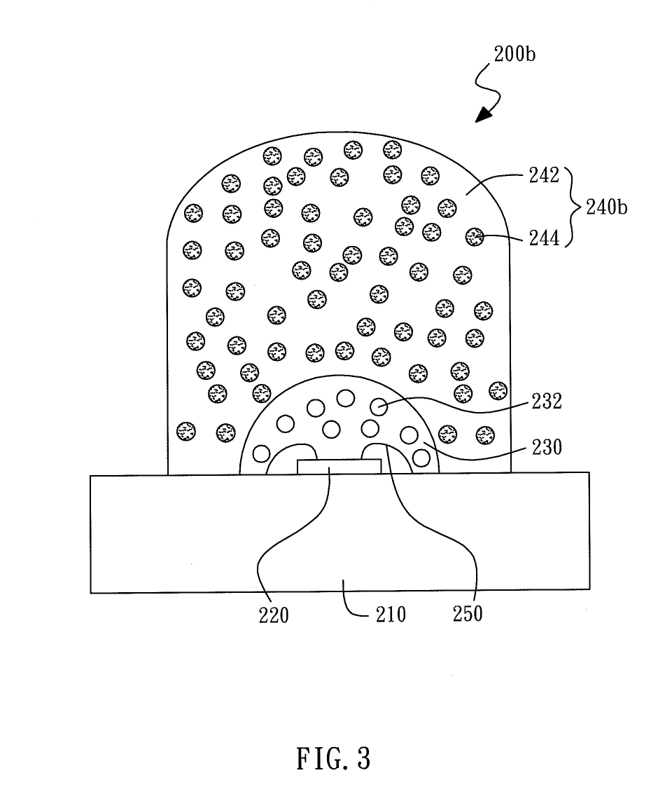

FIG. 3 is a cross-sectional diagram of lighting module according to another embodiment of the present invention. Referring to FIG. 3, the difference between this embodiment and the aforementioned embodiment is that the color temperature converter 240b comprises an optical lens 242 doped with a plurality of dopants 244, wherein the optical lens 242 encapsulates the molding compound 230 and a portion of the carrier 210, the optical lens 242 may be made of silicon or epoxy resin, and the dopants 244 may comprise colourful particles or colourful plastic particles such as polycarbonate particles or silica gel particles.

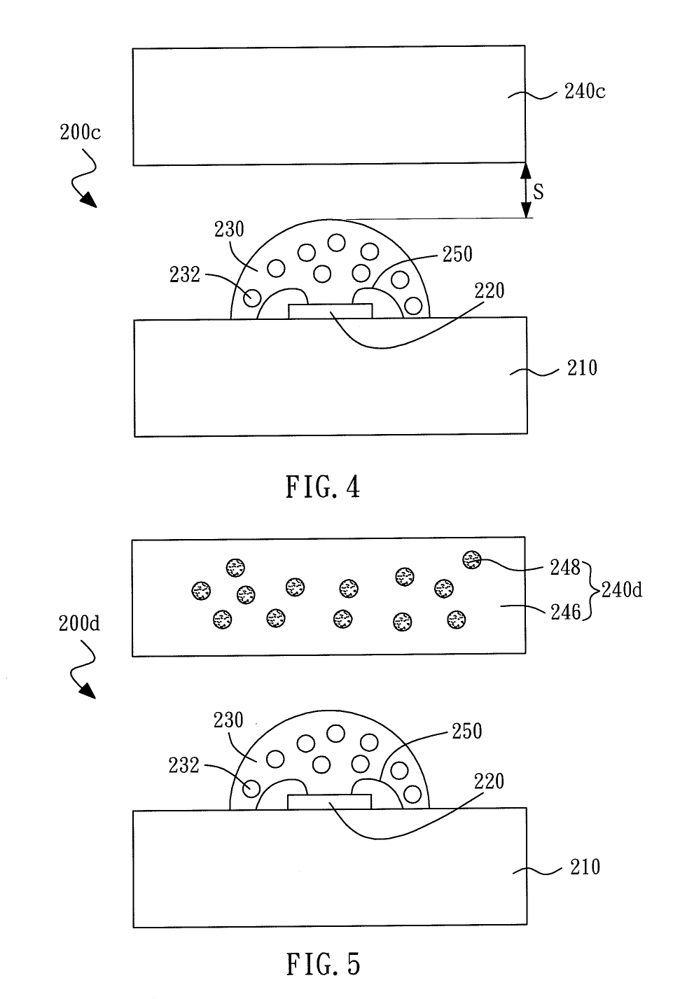

FIG. 4 is a cross-sectional diagram of lighting module according to another embodiment of the present invention. Referring to FIG. 4, the difference between this embodiment and the embodiment shown in FIG. 2 is that the color temperature converter 240c is disposed above the molding compound 230. Specifically, a space S exists between the color temperature converter 240c and the molding compound 230. The color temperature converter 240c is an optical filter, for example. In another embodiment, the color temperature converter 240c may be a substrate coating with color temperature material.

FIG. 5 is a cross-sectional diagram of lighting module according to another embodiment of the present invention. Referring to FIG. 5, the difference between this embodiment and the embodiment shown in FIG. 2 is that the color temperature converter 240d is disposed above the molding compound 230 and the color temperature converter 240d is a substrate 246 doped with a plurality of dopants 248. The dopants 248 may comprise colourful particles or colourful plastic particles such as polycarbonate particles or silica gel particles. In addition, the substrate 246 may be a plastic plate or a glass lens.

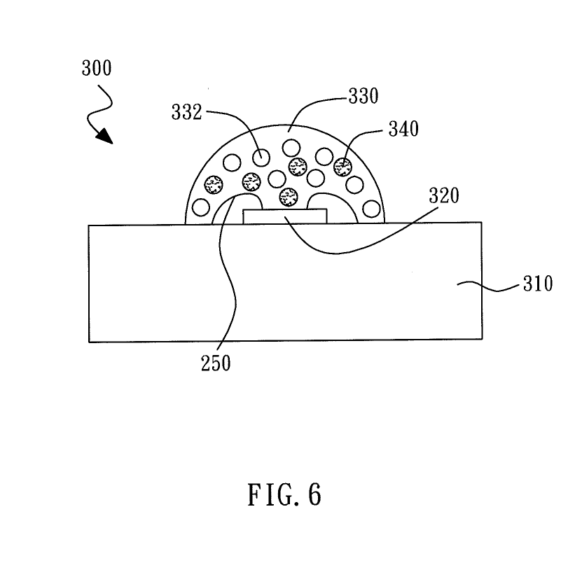

FIG. 6 is a cross-sectional diagram of lighting module according to another embodiment of the present invention. Referring to FIG. 6, the difference between this embodiment and the embodiment shown in FIG. 2 is that the color temperature converter 340 is a plurality of dopants 340. Specifically, the dopants 340 are doped within the molding compound 330 and may comprise colourful particles or colourful plastic particles such as polycarbonate particles or silica gel particles. The light source 320 emits the light through the molding compound 330 and the dopants 340 to the outside. In the light path, the light source 320 emits a light to excite the fluorescent material 332 and thus the fluorescent material 332 emits another light, and the later emitted light is blended with the former emitted light. Simultaneously, the light emitted from the light source 320 strikes the dopants 340 that modulate the blended light and results in the exported light having a desired color temperature and a better color uniformity.

Notice that in other embodiments that are not illustrated, one skilled in the art can refer the descriptions of the above embodiments to modify and/or combine the one or more aforementioned elements, for example, color temperature converter 240a-240d or color temperature dopants 340, to achieve a required technical effect according to his demand.

Accordingly, the embodiments of the present invention provide the color temperature converters that can modulate the color temperature of light emitted from the light source, i.e., the LED chip. Compared with the prior art, the present invention provides more effective and easy way to modulate the color temperature of the light. The color temperature converters provided by the embodiments not only modulate the color temperature but also make the exported light more uniform.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lighting module, comprising:
a carrier;
at least one light source disposed on the carrier and electrically connected to the carrier, the light source comprising a light-emitting diode chip;
a molding compound encapsulating the light source and a portion of the carrier, wherein the molding compound comprises a fluorescent material; and
a color temperature converter disposed over the molding compound;
whereby the light-emitting diode chip emits a first light to excite the fluorescent material to emit a second light, the first light and second light is blended, and the color temperature converter modulates the color temperature and uniformity of the blended light.

2. The lighting module as recited in claim 1, wherein the carrier comprises a printed circuit board, a ceramic circuit substrate, or a leadframe, and the printed circuit board comprises a metal-core printed circuit board with an Al or Cu core layer.

3. The lighting module as recited in claim 1, wherein the light-emitting diode chip is a blue light-emitting diode chip, and the fluorescent material comprises yellow fluorescent particles.

4. The lighting module as recited in claim 1, wherein the light-emitting diode chip is an ultraviolet light-emitting diode chip, and the fluorescent material comprises red fluorescent particles, green fluorescent particles, blue fluorescent particles, or a combination thereof.

5. The lighting module as recited in claim 1, wherein the color temperature converter entirely covers the molding compound.

6. The lighting module as recited in claim 5, wherein the color temperature converter comprises an optical lens doped with a plurality of dopants, the dopants comprise colourful particles or colourful plastic particles, the colourful plastic particles comprise polycarbonate particles or silica gel particles, and the optical lens encapsulates the molding compound and a portion of the carrier.

7. The lighting module as recited in claim 6, wherein the optical lens is made of silicon or epoxy resin.

8. The lighting module as recited in claim 1, wherein the color temperature converter is disposed above the molding compound, and a space exists between the color temperature converter and the molding compound.

9. The lighting module as recited in claim 8, wherein the color temperature converter comprises an optical filter.

10. The lighting module as recited in claim 8, wherein the color temperature converter comprises a substrate doped with a plurality of dopants, the substrate comprises a plastic plate or a glass lens, the dopants comprise colourful particles or colourful plastic particles, and the colourful plastic particles comprise polycarbonate particles or silica gel particles.

11. A lighting module, comprising:
a carrier;
at least one light source disposed on the carrier and electrically connected to the carrier, the light source comprising a light emitting diode chip;
a molding compound encapsulating the light source and a portion of the carrier, wherein the molding compound is mixed with a fluorescent material; and
a plurality of dopants doped within the molding compound;
whereby the light-emitting diode chip emits a first light to excite the fluorescent material to emit a second light, the first light and second light is blended, and the dopants modulates the color temperature and uniformity of the blended light.

12. The lighting module as recited in claim 11, wherein the carrier comprises a printed circuit board, a ceramic circuit substrate, or a leadframe, and the printed circuit board comprises a metal-core printed circuit board with an Al or Cu core layer.

13. The lighting module as recited in claim 11, wherein the light-emitting diode chip is a blue light emitting diode chip, and the fluorescent material comprises yellow fluorescent particles.

14. The lighting module as recited in claim 11, wherein the light emitting diode chip is an ultraviolet light emitting diode chip, and the fluorescent material comprises red fluorescent particles, green fluorescent particles, blue fluorescent particles, or a combination thereof.

15. The lighting module as recited in claim 11, wherein the dopants comprise colourful particles or colourful plastic particles, and the colourful plastic particles comprise polycarbonate particles or silica gel particles.
